(19) United States
(12) Patent Application Publication
(10) Pub. No.: US 2008/0147377 A1
(43) Pub. Date: Jun. 19, 2008

(54) Method and apparatus for supporting input of translated text, and computer product

(75) Inventors: Seiji Okura, Kawasaki (JP); Masaru Fuji, Kawasaki (JP); Tomoki Nagase, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/904,177

(22) Filed: Sep. 26, 2007

(30) Foreign Application Priority Data
Dec. 19, 2006 (JP) 2006-341829

(51) Int. Cl. G06F 17/28

(52) U.S. Cl. 704/3

(57) ABSTRACT

An apparatus supports input of a translation text that corresponds to an original text, using a database in which original words in a first language and translation words respectively corresponding to the original words in a second language are associated. The apparatus includes an acquiring unit, a retrieving unit, a receiving unit, an extracting unit, and a displaying unit. The acquiring unit acquires plural original words by decomposing the original text. The retrieving unit retrieves translation words that are associated, in the database, with the acquired original words. The receiving unit receives input of a character string in the second language. The extracting unit extracts, from the retrieved translation words, translation words that match with and relate to the character string in the second language, as candidates. The displaying unit displays the candidates on a display.

### CROSS-REFERENCE TO RELATED APPLICATIONS

This application is based upon and claims the benefit of priority from the prior Japanese Patent Application No. 2006-341829, filed on Dec. 19, 2006, the entire contents of which are incorporated herein by reference.

### BACKGROUND OF THE INVENTION

1. Field of the Invention

The present invention relates to a technology for supporting input of a translated text using a computer.

2. Description of the Related Art

Conventionally, documentation software such as a word processor is generally used when translating a Japanese text into an English text. When inputting a translated text using such documentation software, each time an equivalent corresponding to an original word or its correct spelling is not clear, a user refers to an auxiliary document such as a dictionary to input an appropriate equivalent, thereby increasing a working time required for the translation.

For example, a technology according to which when a user specifies a word whose equivalent or correct spelling is unclear in inputting a translated text, an equivalent corresponding to the specified word is retrieved from a dictionary database and displayed, is disclosed (for example, Japanese Patent Laid-open Publication No. 2006-107261).

However, since a series of processing (specification processing, retrieval processing, and display processing) is executed in units of word, a user has to specify each word as a translation target and retrieve a corresponding equivalent from a dictionary database even if an original text includes many words whose equivalents or correct spellings are unclear. As a result, work efficiency of inputting a translated text is lowered, thereby increasing a working time.

Since all equivalents retrieved from the dictionary database are displayed as a retrieval result, when many equivalents are retrieved from the dictionary database even though the user grasps a spelling of an equivalent to some extent, the user must visually find an appropriate equivalent from many equivalents displayed as the retrieval result. Consequently, work efficiency of inputting a translated text is lowered, thereby increasing a working time.

### SUMMARY OF THE INVENTION

It is an object of the present invention to at least solve the problems in the conventional technology.

A computer-readable recording medium according to one aspect of the present invention stores therein a program for supporting input of a translation text that corresponds to an original text, using a database in which original words in a first language and translation words respectively corresponding to the original words in a second language are associated. The program causes a computer to execute acquiring plural original words by decomposing the original text; retrieving translation words that are associated, in the database, with the acquired original words; receiving input of a character string in the second language; extracting, from the retrieved translation words, translation words that match with and relate to the character string in the second language, as candidates; and displaying the candidates on a display.

A computer-readable recording medium according to another aspect of the present invention stores therein a program for supporting input of a translation text that corresponds to an original text in a first language, the translation text translated into a second language. The program causes a computer to execute receiving input of a character string in the second language; extracting, as candidates, plural translation words in the second language that match with and relate to the character string from a table including plural original words obtained by decomposing the original text and plural translation words associated with the original words; and displaying the candidates on a display.

An apparatus according to still another aspect of the present invention supports input of a translation text that corresponds to an original text, using a database in which original words in a first language and translation words respectively corresponding to the original words in a second language are associated. The apparatus includes an acquiring unit that acquires plural original words by decomposing the original text; a retrieving unit that retrieves translation words that are associated, in the database, with the acquired original words; a receiving unit that receives input of a character string in the second language; an extracting unit that extracts, from the retrieved translation words, translation words that match with and relate to the character string in the second language, as candidates; and a displaying unit that displays the candidates on a display.

An apparatus according to still another aspect of the present invention supports input of a translation text that corresponds to an original text in a first language, the translation text translated into a second language. The apparatus includes a receiving unit that receives input of a character string in the second language; an extracting unit that extracts, as candidates, plural translation words in the second language that match with and relate to the character string from a table including plural original words obtained by decomposing the original text and plural translation words associated with the original words; and a displaying unit that displays the candidates on a display.

A method according to still another aspect of the present invention is of supporting input of a translation text that corresponds to an original text, using a database in which original words in a first language and translation words respectively corresponding to the original words in a second language are associated. The method includes acquiring plural original words by decomposing the original text; retrieving translation words that are associated, in the database, with the acquired original words; receiving input of a character string in the second language; extracting, from the retrieved translation words, translation words that match with and relate to the character string in the second language, as candidates; and displaying the candidates on a display.

A method according to still another aspect of the present invention is of supporting input of a translation text that corresponds to an original text in a first language, the translation text translated into a second language. The method includes receiving input of a character string in the second language; extracting, as candidates, plural translation words in the second language that match with and relate to the character string from a table including plural original words obtained by decomposing the original text and plural translation words associated with the original words; and displaying the candidates on a display.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an apparatus for supporting input of a translated text according to an embodiment of the present invention;

FIG. 2 is a block diagram of the apparatus;

FIG. 3 is a schematic for illustrating a dictionary database used in the apparatus;

FIG. 4 is a flowchart of processing performed by the apparatus;

FIG. 5 is a schematic for illustrating original text used in the apparatus;

FIG. 6 is a schematic for illustrating original text having a specified target range;

FIG. 7 is a schematic for illustrating original text words in units of language acquired by an acquirer;

FIG. 8 is a schematic for illustrating original text words in units of language acquired by the acquirer;

FIG. 9 is a schematic for illustrating equivalents retrieved by a retriever;

FIG. 10 is a schematic for illustrating equivalents retrieved by the retriever;

FIG. 11 is a schematic for illustrating input candidates displayed on a display;

FIG. 12 is a schematic for illustrating input candidates displayed on the display;

FIG. 13 is a schematic for illustrating arbitrary input candidates displayed on the display;

FIG. 14 is a schematic for illustrating input candidates displayed on the display;

FIG. 15 is a schematic for illustrating equivalents retrieved by the retriever; and

FIG. 16 is a schematic for illustrating original text having a specified target range.

### DETAILED DESCRIPTION OF THE PREFERRED EMBODIMENTS

Exemplary embodiments according to the present invention will be explained in detail with reference to the accompanying drawings.

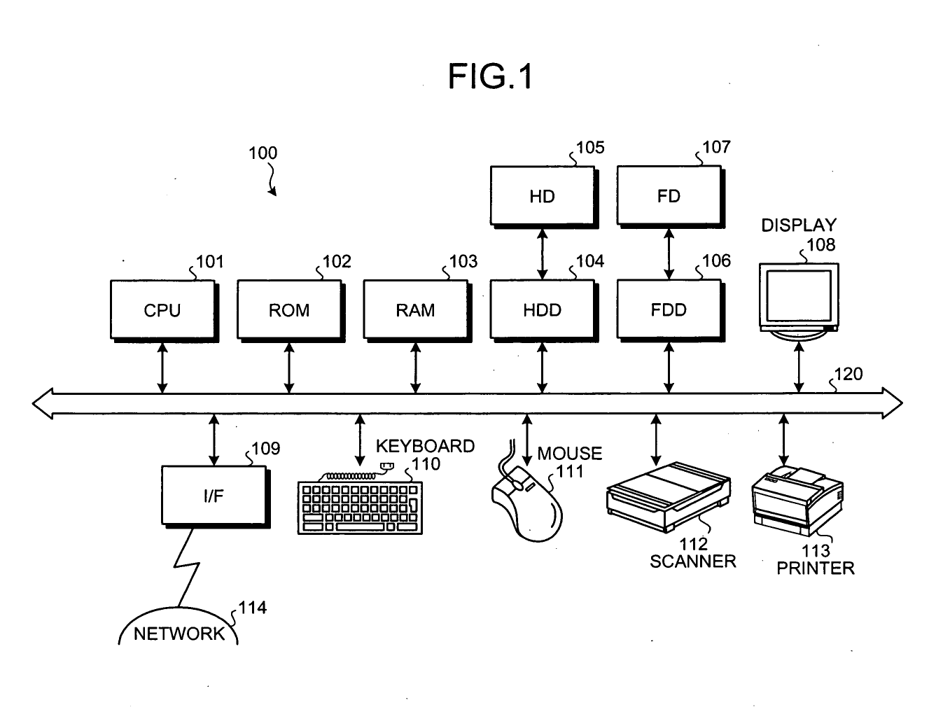

FIG. 1 is a schematic of an apparatus for supporting input of a translated text according to an embodiment of the present invention. An apparatus 100 for supporting input of a translated text includes a central processing unit (CPU) 101, a read only memory (ROM) 102, a random access memory (RAM) 103, a hard disk drive (HDD) 104, a hard disk (HD) 105, a flexible disk drive (FDD) 106, a flexible disk (FD) 107 as an example of a detachable storage medium, a display 108, an interface (I/F) 109, a keyboard 110, a mouse 111, a scanner 112, and a printer 113, and each unit is connected through a bus 120.

The CPU 101 controls the entire apparatus 100. The ROM 102 stores a program such as a boot program. The RAM 103 is used as a work area of the CPU 101. The HDD 104 controls reading/writing data from/to the HD 105 under control of the CPU 101. The HD 105 stores data written under control of the HDD 104.

The FDD 106 controls reading/writing data from/to the FD 107 under control of the CPU 101. The FD 107 stores data written under control of the FDD 106 and causes the apparatus 100 to read data stored in the FD 107.

A compact-disc read-only memory (CD-ROM), a compact-disc recordable (CD-R), a compact-disc rewritable (CD-RW), a magneto optical (MO) disc, a digital versatile disc (DVD), and a memory card may be used as a detachable storage medium besides the FD 107. The display 108 displays not only a cursor, an icon, or a tool box, but also data such as a sentence, an image, and function information. For example, a cathode-ray tube (CRT), a thin-film transistor (TFT) display, a plasma display can be employed as the display 108.

The I/F 109 is connected to a network 114 such as the Internet through a communication line, and connected to other devices through the network 114. The I/F 109 is connected to a communication cable such as a USB cable, and connected to other devices such as a USB device through the communication cable. The I/F 109 is an internal interface between the apparatus 100 and the network 114, and controls input/output of data from other devices connected to the apparatus 100. For example, a modem, an LAN adapter, and a USB port can be adopted as the I/F 109.

The keyboard 110 includes keys to input characters, numbers, and various instructions, and inputs data. A touch-sensitive input pad or a numeric keypad may be adopted. The mouse 111 moves a cursor, selects a range, moves a window, and changes a size. A track ball and a joystick that have a similar function as a pointing device can be used.

The scanner 112 optically reads an image, and captures image data into the apparatus 100. The scanner 112 may have a function of optical character recognition (OCR). The printer 113 prints image data and text data. For example, a laser printer and an inkjet printer can be adopted as the printer 113.

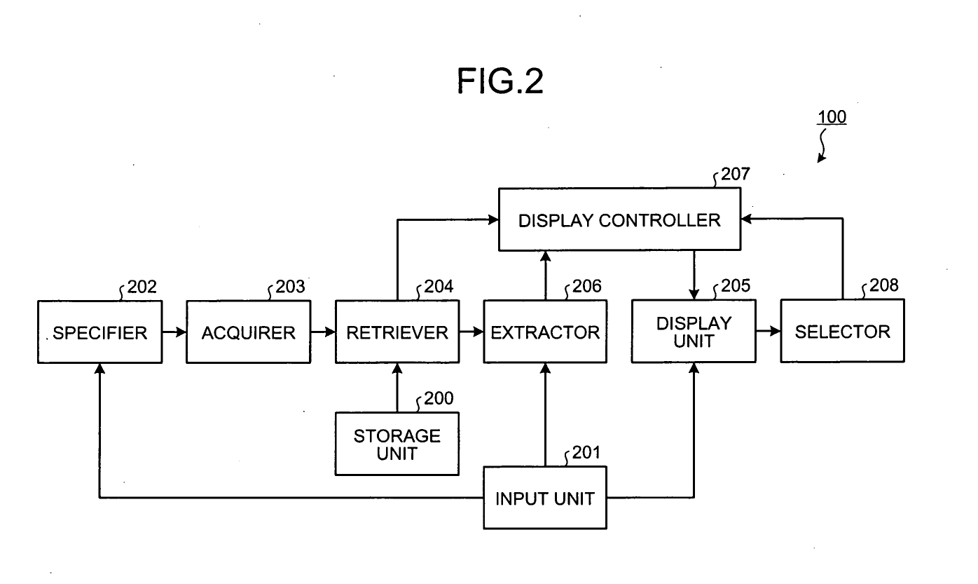

FIG. 2 is a block diagram of the apparatus 100. The apparatus 100 includes a storage unit 200, an input unit 201, a specifier 202, an acquirer 203, a retriever 204, a display unit 205, an extractor 206, a display controller 207, and a selector 208.

The storage unit 200 is a database that stores original text words in units of language such as a word, a phrase, a clause, and a sentence expressed in a first language, and equivalents expressed in a second language respectively corresponding to the original text words in association with each other. An equivalent in units of different language may be associated with an original text word. For example, a language unit of the original text word may be a word, and a language unit of an equivalent of this word may be an idiom. Plural equivalents may be associated with one original text word.

The storage unit 200 is not limited to be provided in the apparatus 100, and may be provided in another device connected to the apparatus 100. Specifically, a function of the storage unit 200 is realized by the ROM 102, the RAM 103, the HD 105, and the FD 107 shown in FIG. 1. Hereinafter, Japanese is used as the first language and English is used as the second language.

The input unit 201 receives input of an original text expressed in the first language (Japanese). The original text is not limited to a text input by a user using a keyboard or a mouse, and may be a text read from a text file recorded in a predetermined storage medium. In this case, the storage medium is not limited to be provided in the apparatus 100, and may be provided in another device connected to the apparatus 100. The input unit 201 also receives input of a character string in the second language (English) as a retrieval key when the extractor 206 explained later executes extraction processing.

Various data input through the input unit 201 are temporarily recorded in a storage medium such as a memory. Specifically, a function of the input unit 201 is realized by the I/F (interface) 109, the keyboard 110, and the mouse 111 shown in FIG. 1.

The specifier 202 receives specification of a range as a target (hereinafter, “target range”) in the original text input through the input unit 201. A target range is specified by a user by dragging original text displayed on a display 108 using a mouse or a keyboard.

The user can specify not only a part but also all (full text) of the original text as a target range. The user can also specify plural target ranges. When a target range is not specified explicitly, all (full text) of the original text implicitly becomes a target range.

The original text having a target range specified by the specifier 202 is temporarily recorded in a recording medium such as a memory. Specifically, a function of the specifier 202 is realized by the I/F (interface) 109, the keyboard 110, and the mouse 111 shown in FIG. 1.

The acquirer 203 acquires original text words in units of language by decomposing a part of the original text corresponding to the target range. The original text can be decomposed by utilizing a known technology such as a morphological analysis program and a phrase extraction program. Specifically, the original text is divided using the morphological analysis program or the phrase extraction program, and original text words belonging to a predetermined word class (for example, a word) are extracted from the divided pieces of the original text.

The original text words in units of language acquired by the acquirer 203 are temporarily recorded in a recording medium such as a memory. Specifically, a function of the acquirer 203 is realized by causing the CPU 101 to execute a program stored in the ROM 102, the RAM 103, the HD 105, and the FD 107 shown in FIG. 1.

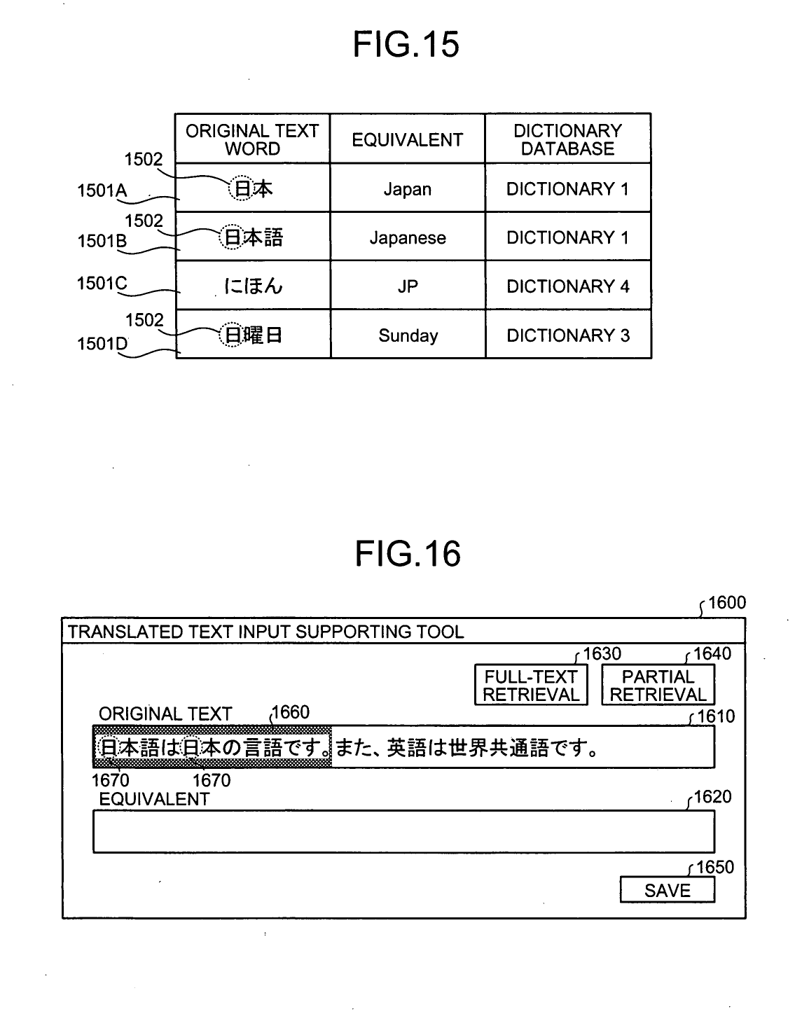

FIG. 15 is a schematic for illustrating equivalents retrieved by the retriever 204. The retriever 204 retrieves, from equivalents stored in the storage unit 200, an equivalent associated with the original text word acquired by the acquirer 203. When plural equivalents are associated with one original text word in the storage unit 200, the retriever 204 retrieves all the associated equivalents from the storage unit 200.

The retriever 204 may retrieve not only an equivalent associated with an original text word but also an equivalent associated with an original text word that partially matches with the original text word. For example, when an original text word 1501A is acquired by the acquirer 203, the retriever 204 may retrieve not only an equivalent “Japan” associated with this original text word 1501A but also an equivalent “Japanese” associated with an original text word 1501B that partially matches with the original text word 1501A.

Conversely, for example, when the original text word 1501B is acquired by the acquirer 203, the retriever 204 may retrieve not only an equivalent “Japanese” associated with the original text word 1501B, but also an equivalent “Japan” associated with the original text word 1501A that partially matches with the original text word 1501B.

In this case, the retriever 204 may retrieve, from partially matched original text words, only an equivalent associated with an original text word satisfying a preset minimum number of matched characters (of Kanji). For example, when “3” is set as the minimum number of matched characters and the original text word 1501B is acquired by the acquirer 203, the original text word 1501A that partially matches with the original text word 1501B has only two matched characters, and hence an equivalent “Japan” associated with the original text word 1501A is out of a retrieval target.

An equivalent retrieved by the retriever 204 is temporarily recorded in a recording medium such as a memory. Specifically, a function of the retriever 204 is realized by causing the CPU 101 to execute a program stored in the ROM 102, the RAM 103, the HD 105, and the FD 107 shown in FIG. 1.

The display unit 205 displays an original text expressed in the first language (Japanese) input through the input unit 201. The display unit 205 displays a character string in the second language (English) input through the input unit 201. The display unit 205 displays equivalents extracted by the extractor 206 under control of the display controller 207 explained later. Specifically, a function of the display unit 205 is realized by the display 108 shown in FIG. 1.

When a character string in the second language (English) is input through the input unit 201, the extractor 206 extracts, from the equivalents retrieved by the retriever 204, equivalents that match with or are associated with the character string as input candidates. For example, when the retriever 204 retrieves “lake”, “life”, and “like” as equivalents and “l” is input as the character string, the extractor 206 extracts “lake”, “life”, and “like” from the equivalents as input candidates.

Subsequently, when “i” is input through the input unit 201 and the character string consequently becomes “li”, the extractor 206 extracts “life” and “like” from the equivalents as input candidates.

When a character string in the first language (Japanese) rather than a character string in the second language (English) is input through the input unit 201, the extractor 206 may extract an original text word that matches with or is associated with the character string in the first language (Japanese) and an equivalent of this original text word as input candidates from equivalents retrieved by the retriever 204. In this case, the retriever 204 retrieves not only equivalents but also Japanese words associated with the equivalents from a dictionary database.

For example, when the retriever 204 retrieves “Japan” corresponding to the original text word 1501A, “Japanese” corresponding to the original text word 1501B, “JP” corresponding to an original text word 1501C, and “Sunday” corresponding to an original text word 1501D, and the input unit 201 receives input of a character string 1502 in the first language (Japanese), the extractor 206 extracts “Japan”, “Japanese”, and “Sunday” as input candidates from the retrieved results.

When a character string in the first language (Japanese) is input through the input unit 201, the extractor 206 may automatically translate a character string in a predetermined range of the original text starting from the input character string (for example, from the input character string to reference character 560 or 570), and determine a translated text as an extraction result.

FIG. 16 is a schematic for illustrating an original text having a specified target range. For example, when a target range 1660 is specified by the specifier 202, and a character string 1670 is input through the input unit 201, translated texts “Japanese is a language of Japan” and “language of Japan” are determined as extraction results.

Input candidates extracted by the extractor 206 are temporarily recorded in a recording medium such as a memory. Specifically, a function of the extractor 206 is realized by causing the CPU 101 to execute a program stored in the ROM 102, the RAM 103, the HD 105, and the FD 107 shown in FIG. 1.

The display controller 207 displays each equivalent (input candidate) extracted by the extractor 206 on the display unit 205. The display controller 207 may display not only an equivalent but also information that specifies a dictionary database having the equivalent registered therein, an original text word, a descriptive text associated with the equivalent, and a type of a phrase of the equivalent at the same time. When an equivalent (input candidate) extracted by the extractor 206 is “Japan”, for example, a display example is “Japan NIHON”, “Japan NIHON xx dictionary”, “Japan NIHON nihon xx dictionary”, and “Japan NIHON xx dictionary noun”.

When the extractor 206 extracts plural equivalents (input candidates), the equivalents may be ranked to be displayed. For example, the equivalents may be displayed in an order of priority in a dictionary database in which the equivalents are registered, or in an order of frequency of use. When the number of the equivalents (input candidates) is equal to or larger than a predetermined number, the equivalents may not be displayed.

The display controller 207 displays, on the display unit 205, an arbitrary input candidate (equivalent) selected by the selector 208 explained later in place of a character string in the second language (English) (input through the input unit 201) already displayed on the display unit 205.

The display controller 207 may display equivalents retrieved by the retriever 204 on the display unit 205. Specifically, a function of the display controller 207 is realized by causing the CPU 101 to execute a program stored in the ROM 102, the RAM 103, the HD 105, and the FD 107.

The selector 208 receives input indicative of an arbitrary input candidate (equivalent) selected from the input candidates (the equivalents) displayed on the display unit 205. For example, a user can select an input candidate using a mouse or an arrow key (↑ and ↓). When the mouse is clicked or an ENTER key is pressed by the user, an input candidate is input in an equivalent region.

An input candidate selected by the selector 208 is temporarily recorded in a recording medium such as a memory. Specifically, a function of the selector 208 is realized by the keyboard 110 or the mouse 111 shown in FIG. 1.

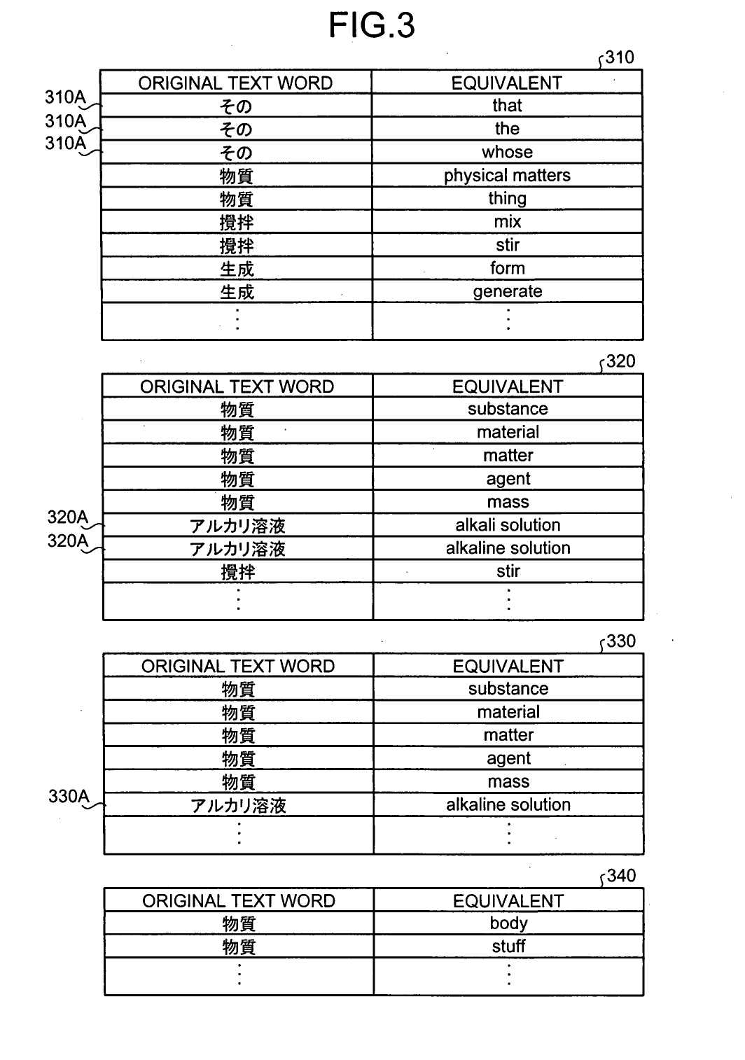

FIG. 3 is a schematic for illustrating a dictionary database used in the apparatus 100. Four different dictionary databases (dictionary databases 310, 320, 330, and 340) are used in the apparatus 100. Each of the dictionary databases 310 to 340 includes at least a data string “original text word” and a data string “equivalent”. Although the number of dictionary database used in the apparatus 100 may be one, using many dictionary databases enables complementing the respective databases.

For example, although no equivalent is associated with an original text word 310A in the dictionary databases 320, 330, and 340, three equivalents “that”, “the”, and “whose” are associated with the original text word 310A in the dictionary database 310, thereby complementing the dictionary databases 320, 330, and 340.

For example, although an equivalent “alkaline solution” alone is associated with an original text word 330A in the dictionary database 330, equivalents “alkaline solution” and “alkali solution” are associated with an original text word 320A in the dictionary database 320, thereby complementing the dictionary database 330.

The dictionary database is not limited to a commercially available database or a generally released database, and a database defined by a user may be used. As a result, an equivalent that is not registered in other dictionary databases or an equivalent that is often used by a user can be associated with an arbitrary original text word.

In the dictionary database, not only an original text word and an equivalent are associated with each other, but also an original text word or an equivalent, and a descriptive text are associated with each other. As a result, a user can select, based on the descriptive text, an arbitrary one from plural equivalents displayed.

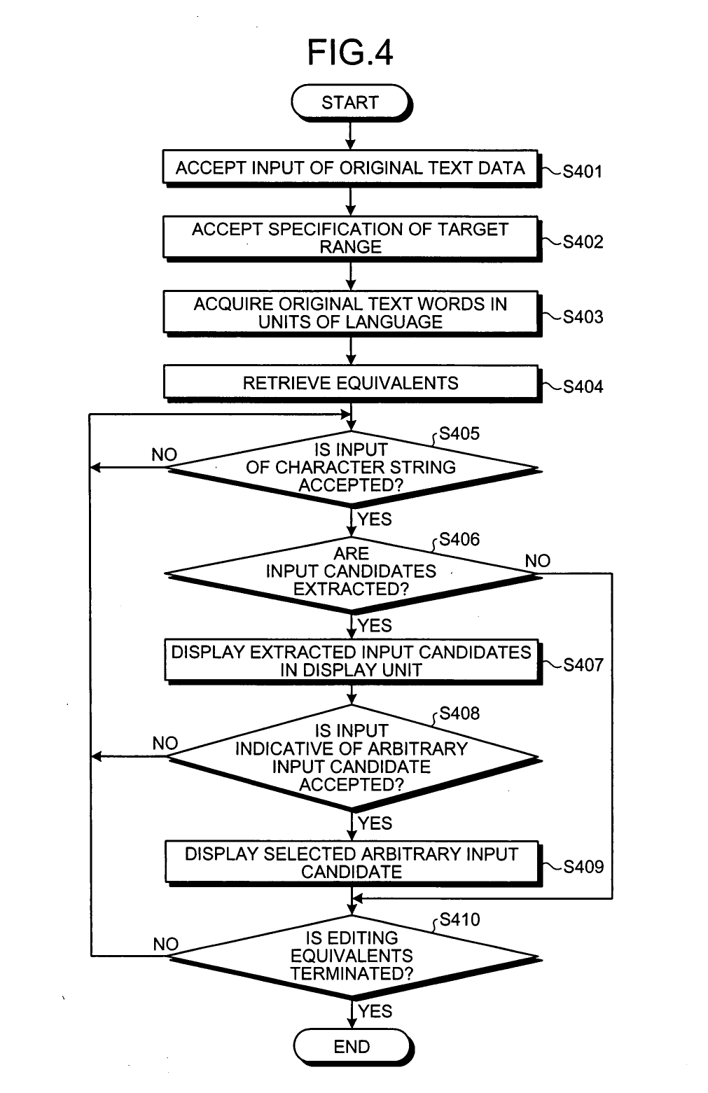

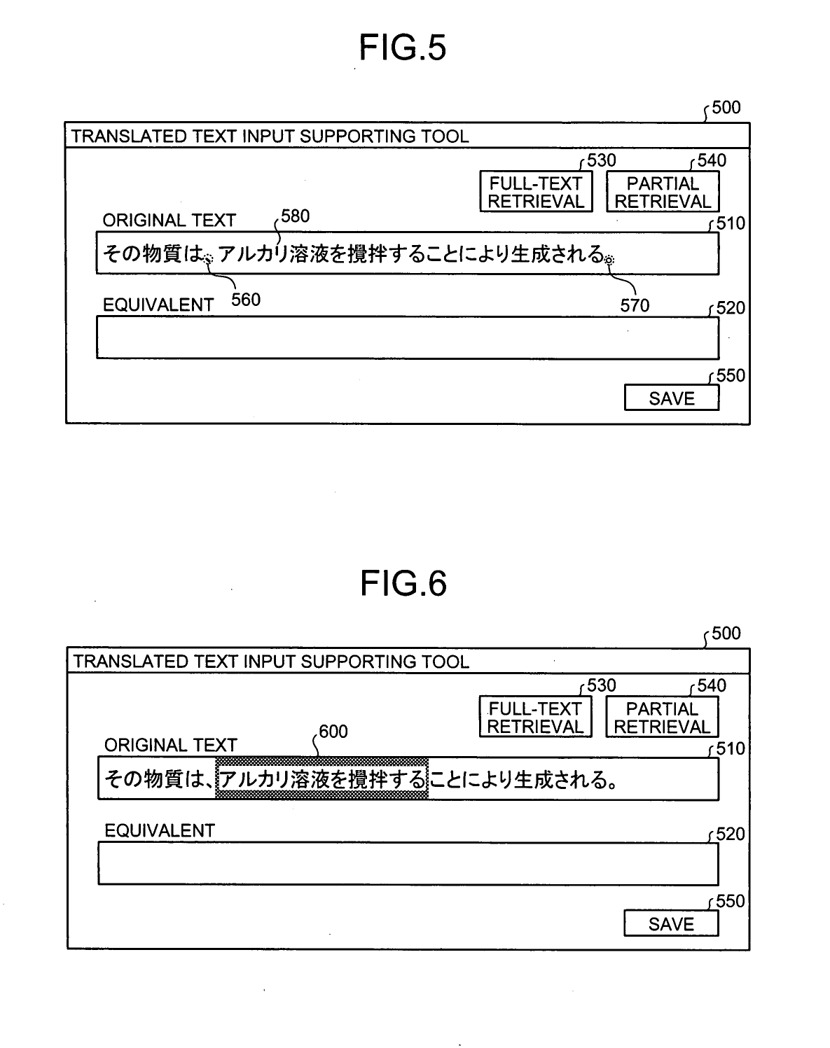

FIG. 4 is a flowchart of processing performed by the apparatus 100. The input unit 201 receives input of an original text in the first language (Japanese) (step S401). An example of the original text input through the input unit 201 will be explained later with reference to FIG. 5.

The specifier 202 receives specification of a target range in the original text (step S402). An example of the original text having the target range will be explained later with reference to FIG. 6.

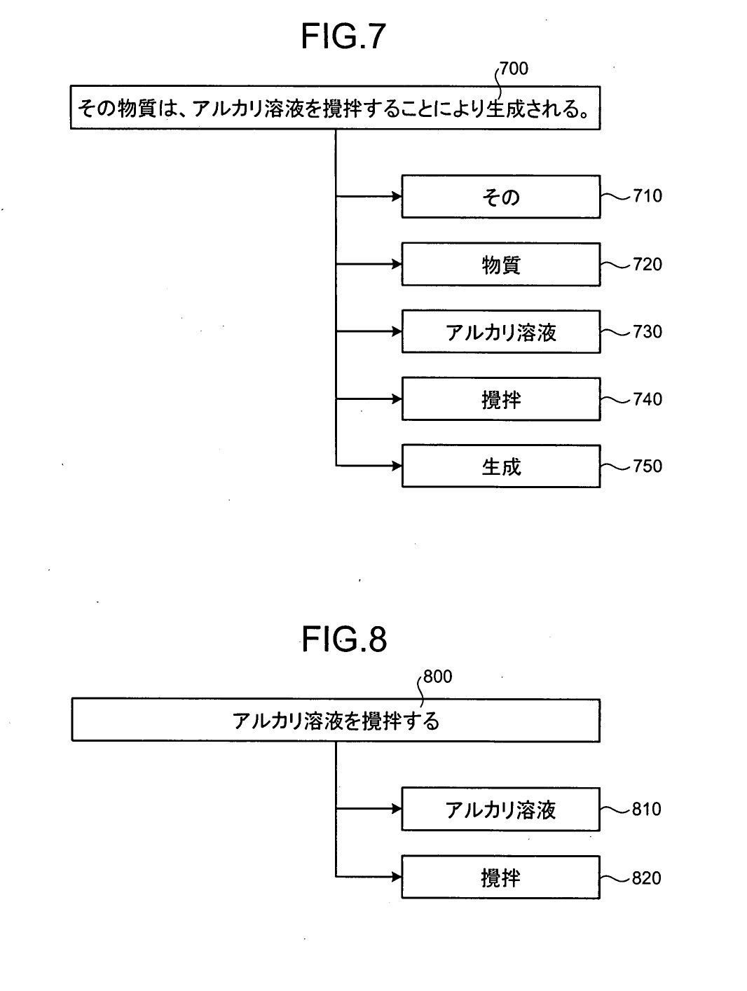

The acquirer 203 acquires original text words in units of language by decomposing a part of the original text corresponding to the target range (step S403). An example of the original text words in units of language will be explained later with reference to FIGS. 7 and 8.

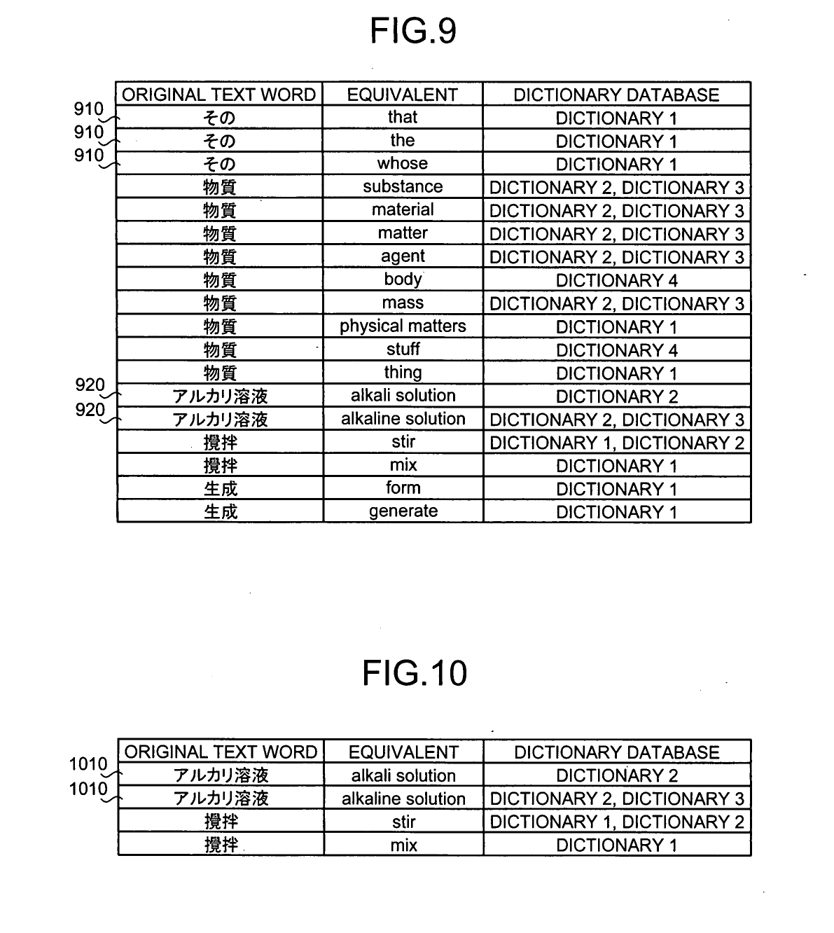

The retriever 204 retrieves, from equivalents stored in the storage unit 200, equivalents associated with the original text words (step S404). An example of the equivalents retrieved by the retriever 204 will be explained later with reference to FIGS. 9 and 10. The display controller 207 may display the equivalents retrieved on the display unit 205.

It is judged whether the input unit 201 receives input of a character string in the second language (English) or the first original language (Japanese) (step S405). When it is determined that input of the character string in the second language (English) or the first original language (Japanese) is not received (step S405: NO), the processing at step S405 is repeatedly executed until when it is determined that input of the character string is received.

On the other hand, when it is determined that input of the character string in the second language (English) or the first original language (Japanese) is received at the step S405 (step S405: YES), it is judged whether the extractor 206 extracts equivalents (input candidates) that match with or are associated with the character string input at step 405 from the equivalents retrieved at the step S404 (step S406).

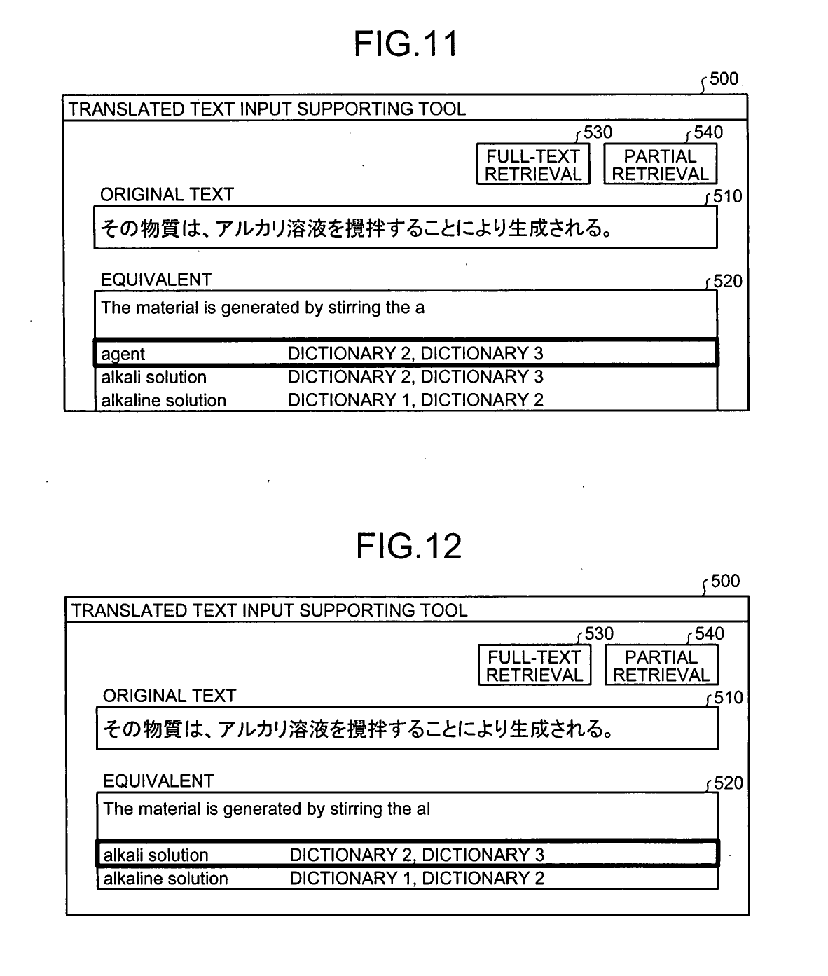

When it is determined that the input candidates are not extracted at the step S406 (step S406: NO), the processing proceeds to step S410. On the other hand, when it is determined that the input candidates are extracted at step S406 (step S406: YES), the display controller 207 displays the input candidates extracted on the display unit 205 (step S407). An example of the input candidates displayed on the display unit 205 will be explained later with reference to FIGS. 11 and 12.

It is judged whether the selector 208 receives input indicative of an arbitrary input candidate selected from the input candidates displayed (step S408). When it is determined that input indicative of the arbitrary input candidate is not received at step S408 (step S408: NO), the processing returns to step S405.

On the other hand, when it is determined that input indicative of the arbitrary input candidate is received at step S408 (step S408: YES), the arbitrary input candidate selected is displayed on the display unit 205 in place of the character string displayed (in the second language (English) or the first original language (Japanese) input through the input unit 201) (step S409), and it is judged whether edit of the equivalents is ended (step S410). Whether edit of the equivalents is ended can be judged by detecting an operation such as “end” or “save” performed by a user.

When it is determined that edit of the equivalents is ended at step S410 (step S410: YES), a series of processing ends. On the other hand, when it is determined that edit of the equivalents is not ended at step S410 (step S410: NO), the processing returns to step S405.

FIG. 5 is a schematic for illustrating original text used in the apparatus 100. A screen 500 is a screen of a translated-text input-supporting tool displayed on the display 108 (see FIG. 1) that executes the series of the processing explained in FIG. 4. The screen 500 includes an original-text input section 510, an equivalent input section 520, a full-text retrieval button 530, a partial retrieval button 540, and a save button 550.

An original text as a translation target is input to the original-text input section 510. For example, an original text 580 is input in the original-text input section 510. An original text is input to the original-text input section 510 by a user using the keyboard 110 or the mouse 111, or by reading data from a text file recorded in a predetermined storage medium.

FIG. 6 is a schematic for illustrating an original text having a specified target range. In the case of the screen 500 shown in FIG. 6, a character string 600 is specified as a target range by a user using the keyboard 110 or the mouse 111 from the original text 580 shown in FIG. 5.

An arbitrary character string in the original text 580, and a full text may be specified as a target range. Plural target ranges may be specified from the original text 580. Note that, the full text implicitly becomes a target range when an explicit target range is not specified.

FIGS. 7 and 8 are schematics for illustrating original text words in units of language acquired by the acquirer 203. In a case shown in FIG. 7, the full-text retrieval button 530 is pressed when a target range is not specified in the case shown in FIG. 5, decomposition using the morphological analysis program or the phrase extraction program is performed for a full text 700 of the original text 580, and the acquirer 203 acquires character strings 710, 720, 730, 740, and 750.

On the other hand, in a case shown in FIG. 8, the partial retrieval button 540 is pressed when a target range 600 is specified in the case shown in FIG. 6, decomposition using the morphological analysis program or the phrase extraction program is performed for character strings 800 corresponding to the target range 600, and the acquirer 203 acquires character strings 810 and 820.

Since original text words acquired by the acquirer 203 is used by the retriever 204 for retrieving an equivalent, the original text words are temporarily recorded in a storage medium such as the ROM 102, the RAM 103, the HD 105, and the FD 107 shown in FIG. 1.

FIGS. 9 and 10 are schematics for illustrating equivalents retrieved by the retriever 204. Retrievals that are retrieved from the dictionary databases 310 to 340 (shown in FIG. 3) by the retriever 204 and associated with the original text 700 shown in FIG. 7 acquired by the acquirer 203, are shown in FIG. 9.

On the other hand, retrievals that are retrieved from the dictionary databases 310 to 340 (shown in FIG. 3) by the retriever 204 and associated with the original text 800 shown in FIG. 8 acquired by the acquirer 203, are shown in FIG. 10.

For example, as shown in FIG. 9, when the original text word 910 is acquired by the acquirer 203, “that”, “the”, and “whose” are retrieved from Dictionary 1 (dictionary database 310) as equivalents associated with the original text word 910. As shown in FIGS. 9 and 10, when the original text word 920 or 1010 is acquired by the acquirer 203, “alkali solution” is retrieved from Dictionary 2 (dictionary database 320) and “alkaline solution” is retrieved from Dictionary 3 (dictionary database 330) as equivalents associated with the original text word 920 or 1010.

Since the equivalent retrieved by the retriever 204 is used by the extractor 206 for extracting an input candidate, the equivalent is temporarily recorded in a storage medium such as the ROM 102, the RAM 103, the HD 105, and the RD 107 shown in FIG. 1.

FIGS. 11 and 12 are schematics for illustrating equivalents retrieved by the retriever 205. In the case of the screen 500 shown in FIG. 11, a character string “a” is input after a character string “The material is generated by stirring the” in the equivalent input section 520.

When the character string “a” is input, equivalents “agent”, “alkali solution”, and “alkaline solution” including the character string “a” that are extracted from the equivalents (retrieved by the retriever 204) shown in FIG. 9 are displayed as input candidates in the screen 500.

On the other hand, in the case of the screen 500 shown in FIG. 12, a character string “al” is input after the character string “The material is generated by stirring the” in the equivalent input section 520 (after the character string “a” is input in FIG. 11).

When the character string “al” is input, the equivalents “alkali solution” and “alkaline solutions” including the character string “al” that are extracted from the equivalents (retrieved by the retriever 204) shown in FIG. 9 are displayed as input candidates in the screen 500.

Thus, when the character string “1” is additionally input in the equivalent input section 520, the three input candidates (“agent”, “alkali solution”, and “alkaline solution”) shown in FIG. 11 are consequently refined to the two input candidates (“alkali solution” and “alkaline solution”) shown in FIG. 12.

A user can select, using the keyboard 110 or the mouse 111, an arbitrary one from the input candidates to display the selected input candidate in the equivalent input section 520 in place of the input character string. In other words, the character string input in the equivalent data section 520 is converted into the input candidate selected.

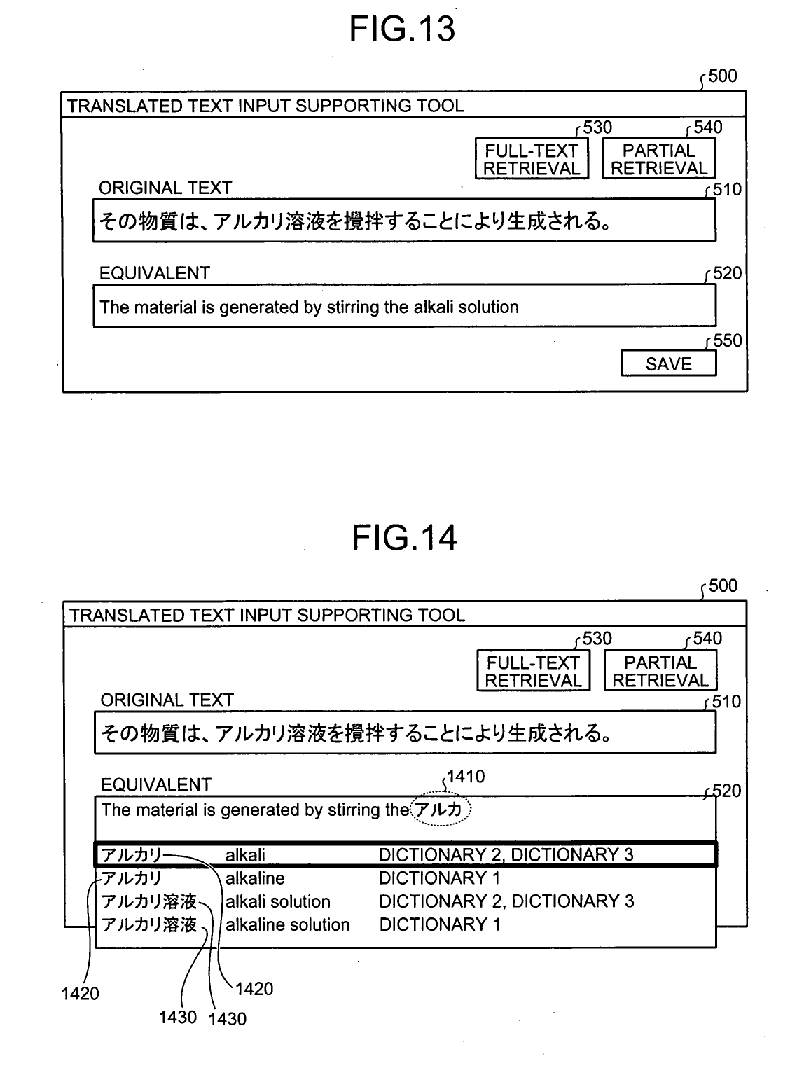

FIG. 13 is a schematic for illustrating arbitrary input candidates displayed on the display 205. In the case of the screen 500 shown in FIG. 13, an arbitrary input candidate “alkali solution” is selected from the two input candidates (“alkali solution” and “alkaline solution”) shown in FIG. 12.

When the input candidate “alkali solution” is selected, the selected input candidate “alkali solution” is displayed following the character string “The material is generated by stirring the” in the equivalent input section 520.

FIG. 14 is a schematic for illustrating input candidates displayed on the display 205. As shown in the screen 500, a character string 1410 in Japanese (first original language) rather than a character string in English (second original language) is input after the character string “The material is generated by stirring the” in the equivalent input section 520.

When the character string 1410 in Japanese is input, the original text words 1420 and 1430 including the character string 1410, and their equivalents “alkali”, “alkaline”, “alkali solution”, and “alkaline solution” retrieved from dictionary databases (not shown) are displayed as input candidates in the screen 500.

For example, when “alkali solution” is selected from these input candidates, the selected input candidate “alkali solution” is displayed in the equivalent input section 520 following the input character string “The material is generated by stirring the”.

As explained above, according to the embodiments, the apparatus 100 retrieves equivalents that are associated with input original text from the dictionary databases 310 to 340. Then, the apparatus 100 extracts equivalents including the input character string from the retrieved equivalents, and displays the extracted equivalents as input candidates to a user. Furthermore, the apparatus 100 inputs an input candidate selected by the user as equivalent data on behalf of the user.

As a result, an equivalent that is less associated with the original text and unnecessary for the user is prevented from being displayed for the user. An equivalent that does not include a character string input by the user is prevented from being displayed for the user. Therefore, a user can readily and appropriately input the intended equivalent by performing a simple operation such as inputting a small character string (for example, a top character) and selecting a target input candidate from input candidates that are highly associated with the original text and include the character string input by the user. As a result, work efficiency of inputting a translated text can be improved.

Since the apparatus 100 specifies a target range, equivalents that are associated with the specified target range in original text are retrieved from the dictionary databases 310 to 340. Equivalents including an input character string is extracted from the retrieved equivalents, and displayed as input candidates for the user. An input candidate selected by the user can be input as equivalent data on behalf of the user.

As a result, an equivalent that is unnecessary for the user and less associated with the target range is prevented from being displayed for the user. Furthermore, an equivalent that does not include the character string input by the user is prevented from being displayed for the user. Therefore, a user can readily and appropriately input the intended equivalent by performing a simple operation such as inputting a small character string (for example, a top character) and selecting a target input candidate from input candidates that are highly associated with the original text and include the character string input by the user. Consequently, work efficiency of inputting a translated text can be improved.

The apparatus 100 may include a calculator that calculates a degree of reliability of each equivalent retrieved by the retriever 204. The display controller 207 may display information on the degree of reliability with each of equivalents (input candidates) on the display unit 205. As a result, a user can select a more reliable input candidate from the displayed input candidates.

In this case, the calculator may determine the number of hits as the degree of reliability when retrieval is executed in a previously prepared database (storing a pair of an example sentence in a first language (original example sentence) and an example sentence in a second language (translated example sentence)) using a pair of an original text word acquired by the acquirer 203 and an equivalent (input candidate) extracted by the extractor 206 as a retrieval key. The higher number of hits indicates the higher degree of reliability.

A weighted value may be set for each dictionary database, and a value obtained by multiplying the number of hits by the weighted value may be determined as the degree of reliability. An equivalent (input candidate) with the larger calculated value may be used as an equivalent (input candidate) with the higher degree of reliability.

A symbol “*” may be assigned to an input candidate with a high degree of reliability so that this input candidate can be displayed as “*: Japan NIHON” on the display unit 205, or a symbol “x” may be assigned to an input candidate with a low degree of reliability so that this input candidate can be displayed as “x: JP nihon”. The method of displaying information on reliability is not limited to the above method. For example, an input candidate with a high degree of reliability may be displayed in a bold type or with an underline, or character color of the input candidate may be changed. Any method can be used as long as a degree of reliability can be easily identified.

According to the method and apparatus, and the computer product, the user can easily and appropriately input a translated text, thereby improving work efficiency.

The method of supporting input of a translated text explained in the embodiments can be realized by executing a previously prepared program by a personal computer such as a workstation, a computer, a CAD, etc. The program is recorded in a computer-readable recording medium such as an HD, an FD, a CB-ROM, an MO, and a DVD, and is executed by being read from the storage medium by a computer. The program may be a transmission medium that can be distributed through a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a program for supporting input of a translation text that corresponds to an original text, using a database in which original words in a first language and translation words respectively corresponding to the original words in a second language are associated, the program causing a computer to execute:
acquiring a plurality of original words by decomposing the original text;
retrieving translation words that are associated, in the database, with the acquired original words;
receiving input of a character string in the second language;
extracting, from the retrieved translation words, translation words that match with and relate to the character string in the second language, as candidates; and
displaying the candidates on a display.

2. The computer-readable recording medium according to claim 1, wherein the program further causes the computer to execute:
receiving input indicative of a candidate selected from among the candidates, and
displaying, on the display, the selected candidate in place of the character string.

3. The computer-readable recording medium according to claim 1, wherein
the program further causes the computer to execute receiving designation of a range in the original text, and
the acquiring includes acquiring the original words by decomposing a part of the original text corresponding to the range.

4. The computer-readable recording medium according to claim 1, wherein
the program further causes the computer to execute calculating a degree of reliability for each of the translation words,
the displaying includes displaying, on the display, information on the degree of reliability with each of the candidates.

5. The computer-readable recording medium according to claim 1, wherein the program further causes the computer to execute:
receiving input of a character string in the first language; and
extracting, from among the translation words, translation words that match with and relate to the character string in the first language, as candidates.

6. The computer-readable recording medium according to claim 1, wherein the displaying includes displaying the candidates in an order based on predetermined conditions.

7. The computer-readable recording medium according to claim 1, wherein the candidates are not displayed at the displaying when number of the candidates is larger than a predetermined number.

8. The computer-readable recording medium according to claim 1, wherein the program further causes the computer to execute displaying the retrieved translation words.

9. The computer-readable recording medium according to claim 1, wherein the program further causes the computer to execute:
receiving input of a character string in the first language; and
generating, as the candidates, translation text strings corresponding to a predetermined range of the original text starting from the character string in the first language.

10. A computer-readable recording medium that stores therein a program for supporting input of a translation text that corresponds to an original text in a first language, the translation text translated into a second language, the program causing a computer to execute:
receiving input of a character string in the second language;
extracting, as candidates, a plurality of translation words in the second language that match with and relate to the character string from a table including a plurality of original words obtained by decomposing the original text and a plurality of translation words associated with the original words; and
displaying the candidates on a display.

11. An apparatus that supports input of a translation text that corresponds to an original text, using a database in which original words in a first language and translation words respectively corresponding to the original words in a second language are associated, the apparatus comprising:
an acquiring unit that acquires a plurality of original words by decomposing the original text;
a retrieving unit that retrieves translation words that are associated, in the database, with the acquired original words;
a receiving unit that receives input of a character string in the second language;
an extracting unit that extracts, from the retrieved translation words, translation words that match with and relate to the character string in the second language, as candidates; and
a displaying unit that displays the candidates on a display.

12. An apparatus that supports input of a translation text that corresponds to an original text in a first language, the translation text translated into a second language, the apparatus comprising:
a receiving unit that receives input of a character string in the second language;
an extracting unit that extracts, as candidates, a plurality of translation words in the second language that match with and relate to the character string from a table including a plurality of original words obtained by decomposing the original text and a plurality of translation words associated with the original words; and
a displaying unit that displays the candidates on a display.

13. A method of supporting input of a translation text that corresponds to an original text, using a database in which original words in a first language and translation words respectively corresponding to the original words in a second language are associated, the method comprising:
acquiring a plurality of original words by decomposing the original text;
retrieving translation words that are associated, in the database, with the acquired original words;
receiving input of a character string in the second language;
extracting, from the retrieved translation words, translation words that match with and relate to the character string in the second language, as candidates; and
displaying the candidates on a display.

14. A method of supporting input of a translation text that corresponds to an original text in a first language, the translation text translated into a second language, the method comprising:
receiving input of a character string in the second language;
extracting, as candidates, a plurality of translation words in the second language that match with and relate to the character string from a table including a plurality of original words obtained by decomposing the original text and a plurality of translation words associated with the original words; and
displaying the candidates on a display.
